(19) United States
(12) Patent Application Publication
(10) Pub. No.: US 2020/0110271 A1
(43) Pub. Date: Apr. 9, 2020

(54) Photosensor Oculography Eye Tracking For Virtual Reality Systems

(71) Applicant: Board of Trustees of Michigan State University, East Lansing, MI (US)

(72) Inventors: Oleg KOMOGORTSEV, Austin, TX (US); Raimondas ZEMBLYS, Siauliai (LT)

(73) Assignee: Board of Trustees of Michigan State University, East Lansing, MI (US)

(21) Appl. No.: 16/592,106

(22) Filed: Oct. 3, 2019

Related U.S. Application Data
(60) Provisional application No. 62/741,168, filed on Oct. 4, 2018.

(51) Int. Cl. G02B 27/01; G06F 3/01; G06K 9/00; G06N 3/04

(52) U.S. Cl. CPC G02B 27/0179; G06F 3/013; G02B 2027/0187; G06N 3/04; G06K 9/00597

(57) ABSTRACT

A virtual reality (VR) system includes a light source configured to illuminate an area and a plurality of photosensors configured to receive reflections from the illuminated area. The system includes a trained orientation module configured to store a trained neural network model and a gaze direction identification module coupled to the light source and the plurality of photosensors. The gaze direction identification module includes a light reflection module configured to receive a light intensity value from each of the plurality of photosensors and an eye coordinate determination module configured to apply the trained neural network model to the light intensity value from each of the plurality of photosensors to determine a horizontal coordinate value and a vertical coordinate value. The system includes a display configured to adjust a displayed image based on the gaze position of the illuminated area.

### CROSS REFERENCE

This application claims the benefit of U.S. Provisional Application 62/741,168, filed Oct. 4, 2018. The entire disclosure of the above application is incorporated herein by reference.

### FIELD

The present disclosure relates to eye tracking and, more specifically, to compensating for equipment movement when tracking a user's gaze.

### BACKGROUND

Virtual reality (VR) and its applications are a fast-growing market expected to reach a market share of 40 Billion USD in 2020. Eye tracking is one of the key components that makes virtual reality more immersive and, at the same time, allows to reduce computational burden via a technique that is called foveated rendering. Tracking users' gaze allows natural and intuitive interaction with virtual avatars and virtual objects. Not only are users able to pick up objects or aim where the user is looking, but also, for example, users are able to interact with virtual characters in non-verbal ways. Moreover, the surrounding virtual environment can be designed to be responsive to a user's gaze. For example, the overall illumination of the scene can be changed, depending on if the user is looking at or near the source of illumination, or away from it, simulating the eye's natural ability to adapt to illumination changes.

Furthermore, a technique known as foveated rendering helps save computational resources and enable lightweight, low-power, and high-resolution VR technologies. Eye tracking hardware in modern VR headsets predominantly consist of one or more infrared cameras and one or more infrared LEDs to illuminate the eye. Such hardware, together with image processing software (and additional hardware to run it) consumes substantial amounts of energy and, provided that hi-speed accurate gaze detection is needed, might be very expensive. A promising technique to overcome these issues is photosensor oculography (PS-OG), which allows eye tracking with high sampling rate and low power consumption by relying on the amount of light reflected from the eye's surface and usually consists of a pair of infrared light-emitting diodes (LEDs) and photosensors. However, the main limitation of the previous PS-OG systems is the inability to compensate for equipment shifts.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A virtual reality (VR) system includes a light source configured to illuminate an area and a plurality of photosensors configured to receive reflections from the illuminated area. The system includes a trained orientation module configured to store a trained neural network model and a gaze direction identification module coupled to the light source and the plurality of photosensors. The gaze direction identification module includes a light reflection module configured to receive a light intensity value from each of the plurality of photosensors and an eye coordinate determination module configured to apply the trained neural network model to the light intensity value from each of the plurality of photosensors to determine a horizontal coordinate value and a vertical coordinate value. The horizontal coordinate value and the vertical coordinate value indicate a gaze position within the illuminated area. The system includes a display configured to adjust a displayed image based on the gaze position of the illuminated area.

In other aspects, the gaze direction identification module is configured to identify a portion of a present display image that corresponds to the gaze position. In other aspects, the display is configured to adjust the displayed image by improving a quality of the identified portion of the present display image for display.

In other aspects, the trained neural network model receives calibration data for each user. In other aspects, the calibration data for a first user is obtained by, for each known image location of a set of known image locations, storing a corresponding light intensity value, wherein the corresponding light intensity value is obtained when a gaze direction of the first user is directed to the corresponding known image location.

In other aspects, the trained neural network model is a multi-layer perceptron neural network configured to implement a mapping function. In other aspects, the trained neural network model is a convolutional neural network trained using a training set including position and light intensity correspondence information. In other aspects, the system includes a mirror configured to direct reflections from the illuminated area to the plurality of photosensors. In other aspects, the plurality of photosensors are configured to measure an intensity of reflections that correspond to the light intensity value and arranged in a grid.

In other aspects, adjusting the displayed image includes orienting the displayed image based on the gaze position indicating a viewing direction. In other aspects, an eye of a user is placed at or near the illuminated area. In other aspects, the system includes a power source or energy source configured to supply power to the light source, the plurality of photosensors, and the gaze direction identification module. In other aspects, the power source is a battery. In other aspects, the display is configured to display instructions to guide a new user through training.

A virtual reality (VR) method includes illuminating an area with a light and receiving reflections from the illuminated area at a plurality of photosensors. The method includes receiving a light intensity value from each photosensor of the plurality of photosensors and determining a gaze direction by applying a trained machine learning algorithm to the received light intensity values. The method includes obtaining a present display screen and determining an area of the present display screen corresponding to the gaze direction. The method includes adjusting the area of the present display screen and displaying a display screen including the adjusted area of the present display screen.

In other aspects, positional information is stored for each photosensor of the plurality of photosensors. In other aspects, the gaze direction includes a horizontal coordinate value and a vertical coordinate value. In other aspects, the adjusting the area of the present display screen includes improving an image quality of the area of the present display screen. In other aspects, the adjusting the area of the present display screen includes reducing an image quality of the present display screen excluding the area of the present display screen.

A virtual reality (VR) system includes a light source configured to illuminate an area and a plurality of photosensors configured to receive reflections from the illuminated area. The system includes at least one processor and a memory coupled to the at least one processor. The memory stores a trained neural network model and a photosensor position database including for position information of the plurality of photosensors included in the VR system. The memory also stores instructions that, upon execution, cause the at least one processor to receive a light intensity value from each photosensor of the plurality of photosensors and determine a horizontal coordinate value and a vertical coordinate value corresponding to a gaze direction by applying the trained neural network model to the light intensity values of each photosensor. The instructions include obtaining a present display, adjusting the present display based on the horizontal coordinate value and the vertical coordinate value, and displaying the adjusted present display.

VR is a rapidly growing market with a wide variety of applications, such as entertainment, medical evaluations and treatment, training, advertising, and retail. A key part of improving VR devices is targeting performance and portability (for example, energy costs). One method for doing this is eye tracking. Eye tracking can reduce computational burden through a method called foveated rendering, in which the scene in the VR device is rendered at higher resolutions where the user is looking and lower quality where the user is not looking. Foveated rendering has the potential to massively reduce computational costs of VR and create a higher quality user experience with cheaper hardware and lower energy consumption.

In addition, eye tracking can improve user experience by allowing a user to interact with an object the user is looking at or changing the environment based on what or which direction the user is looking. One such VR game is controlled entirely according to the user's gaze. Knowing the user's gaze can help configure the screen placement for maximum comfort for users with different inter-pupillary distances or change focal depth without needing to alter rendering. Eye tracking can also make social avatars look more realistic by copying the user's eye movements and blinks. All of these features enhance user immersion, providing a substantial improvement in the field of VR.

While current VR devices may include measuring user head movements, most VR devices currently available do not include eye tracking. Currently on the market are devices that use video oculography (VOG). VOG devices take a photo of the eye using a CCD camera and calculate gaze position based on the features of the eye present in that photo. This process has high power consumption due to processing imaging cost and can be slow. VOG has relatively high cost due to the camera cost.

An alternate method is photosensor oculography (PS-0G), which consists of a set of transmitters and receivers (can be in a form of a sensor array) of infra-red light and measures the amount of light reflected from various areas of user's eyes. Different areas of the eye (including periocular regions) reflect different amounts of light, thus allowing to estimate eye gaze direction. However, PS-OG is extremely sensitive to equipment shifts that may occur when VR headset moves on a user's head. Such equipment shifts may cause severe degradation of the captured eye movement signal. In various implementations, a scanning mirror device may use PS-OG with a scanning mirror instead of a sensor array. While the scanning mirror device is faster and requires less power consumption than a VOG device, it is sensitive to equipment shifts. The presently disclosed system uses an array of sensors run by a neural network. The calibrated neural network is robust to equipment shifts and requires no motors.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram depicting a virtual reality (VR) headset system.

FIG. 2 is a graphical depiction of a movement pattern for sensor calibration.

FIGS. 3A-3D depict example photosensor layouts within a VR headset system.

FIG. 4 is an example implementation of a functional block diagram of a gaze direction identification module.

FIG. 5 is a flowchart depicting an example implementation of gaze detection of a user's eye.

In the drawings, reference numbers may be reused to identify similar and/or identical elements.

### DETAILED DESCRIPTION

A virtual reality (VR) system employing a machine learning method for training a photosensor oculography (PS-OG) system for user eye tracking that is resistant to equipment shifts is presented. In PS-OG, light reflected from the surface of the eye and surrounding regions is measured by a sensor such as an infrared phototransistor. The calibration consists of users looking at a series of dots and moving the headset around while looking at each presented dot. In various implementations, a neural network is trained using machine learning methods. The trained neural network fully compensates for equipment shifts and increases spatial accuracy of a user's gaze detection. The presently disclosed system and method are capable of running at much faster sampling frequency (at 1000 Hz or greater) than video oculography techniques at a fraction of power cost that is required by a video oculography system. That is, the presently disclosed system and method are more accurate than existing eye tracking systems while achieving high level of accuracy with very little power consumption. Proposed system can accurately estimate a gaze direction even during equipment shifts.

Photosensor layouts are also important for accurate eye tracking. In general, more sensors produce more accurate data still maintaining a low computational load and placing the sensors close together increases correlation between sensors. In various implementations, a grid layout with minimal overlap between sensor data can be employed.

While the sensors require minimal power, unlike cameras, the calculations involving neural networks can potentially be power consuming. However, as tested on a top-of-the-line desktop GPU, the power consumption is comparable to or lower than methods that use an image sensor. The presently disclosed system samples the eye positional signal much faster than contemporary video oculography methods at the same or lower power cost. Additionally, the disclosed VR system uses less expensive materials, such as photosensors versus image sensors for video oculography systems.

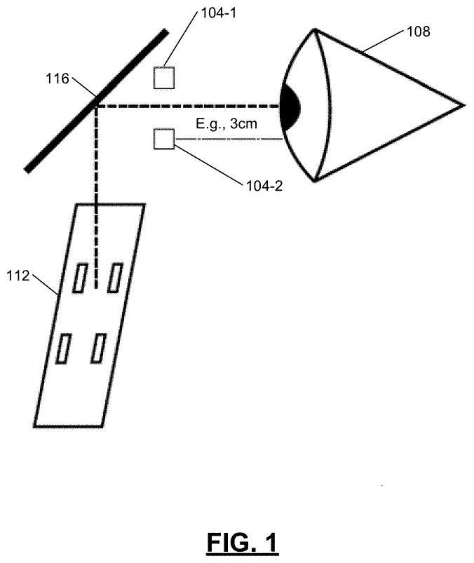

Referring to FIG. 1, a diagram depicting a VR headset system 100 is shown. The VR headset system 100 includes light sources 104-1 and 104-2 that transmit light. For example, the light sources 104-1 and 104-2 may be light-emitting diodes or another type of light-emitting sources. In various implementations, the light sources 104-1 and 104-2 may emit infrared light. In this way, the light would not interfere with a user who is using the VR headset system 100. The light from the light sources 104-1 and 104-2 is directed toward an eye 108 of the user. The VR headset system 100 shows the system covering one eye 108. The VR headset system 100 may include similar devices for each eye within the same system. The VR headset system 100 is operated by a power source or energy source, such as a battery. In various implementations, an AC wall outlet may be providing power to the VR headset system.

The light source 104-1 and 104-2 illuminates the eye 108 of the user and any light that is reflected from the eye 108 may be received by a sensor grid 112. In various implementations, the sensor grid 112 includes photosensors (for example, a phototransistor) that measure the light reflected from the eye 108. The raw output data of photosensors is usually voltage, lux, or other arbitrary units. Therefore, calibration is needed to map the outputs to gaze locations on a VR display of the VR headset system 100. In various implementations, the light sources 104-1 and 104-2 and the sensory grid 112 are connected to a processor that controls the transmission of light from the light sources 104-1 and 104-2 and receives the raw output data of the sensor grid 112 for further processing. The VR headset system 100 may include a plurality of light sources and photosensors in the sensor grid 112 in various layouts.

Calibration of the of the VR headset system 100 is usually performed by displaying a number of targets at known locations on the display while the user is asked to follow these targets. A mapping function then can be trained using n-th order regression or other techniques. In case of headset shifts, however, the geometry of the setup changes. Therefore, mapping obtained during the calibration procedure becomes invalid and results in offsets in the estimated gaze location. To compensate for hardware shifts by only using the raw output data from photosensors, one needs to also model photosensor raw output data during the shifts. The calibration function needs to have data from what the photosensor “sees” when the photosensor is in different positions with respect to the eye 108 and periocular area in general.

Moreover, instead of using explicitly estimated photosensor positions, a neural network is trained, which robustly handles hardware shifts only using data from photosensors obtained while looking at calibration targets, and shifting sensors around. In various implementations, a multi-layer perceptron (MLP) neural network may be used as a mapping function, which is essentially an ensemble of linear regressors with non-linear activation functions. Such an approach does not need the VOG component and solves additional limitations of presently known techniques.

In addition, training an MLP model from scratch may be very computationally expensive. In various implementations, a pre-trained neural network model may be used and only fine-tuned for new user data. Further, other neural network architectures may be used, such as convolutional neural networks (CNN). CNN could act as a dimensionality reduction method, which would also be able to extract useful features. CNN weights could also be pre-trained using large datasets of photosensor responses and then remain fixed when training individual calibration functions for each user.

As shown in FIG. 1, a mirror 116 may be placed, for example, five centimeters away from a pupil center of the eye 108. The mirror 116 may be an infrared reflective mirror. The sensor grid 112 is located beneath the eye 108. The light reflected from the eye 108 is reflected off the mirror 116 and received at the sensor grid 112 where the photosensors measure an intensity of the light reflected. Since various parts of the eye 108 including periocular regions reflect different amount of light, eye gaze direction can be estimated from the reflection of light from the surface of the eye 108. Further details regarding example VR hardware systems may be found in “Developing Photo-Sensor Oculography (PS-OG) system for Virtual Reality headsets,” ETRA '18, Jun. 14-17, 2018, Warsaw Poland and “Making stand-alone PS-OG technology tolerant to the equipment shifts,” PETMEI '18, Jun. 14-17, 2018, Warsaw Poland, which are incorporated by reference in their entirety.

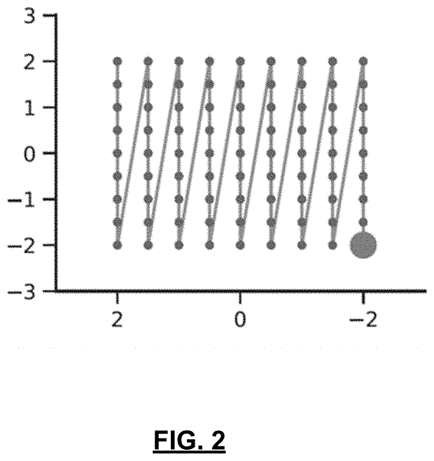

Referring to FIG. 2, a graphical depiction of an example implementation of a movement pattern for a sensor calibration is shown. When using the VR headset system of FIG. 1, a user may be instructed to look at a particular area—for example, a dot displayed on the VR headset. To calibrate the system, the user may further be instructed to fixate on the dot and move the headset around in a zig-zag pattern as graphed in FIG. 2 to simulate equipment shifts during standard use. For each VR session, the user would be asked to fixate on particular areas of the display and move the headset in certain patterns to ensure the VR headset system can account for equipment shifts and properly track the user's gaze. Since the position of each photosensor on a sensor grid is known and the position of the dot as well as any pattern the user is requested to follow is known, the VR headset system may receive the reflected light intensity of the user's eye and compare that with the known location the user should be looking.

With respect to the trained neural network, the neural network may be trained using machine learning methods and collecting data from a training group including a plurality of potential users. The trained neural network can learn, based on the calibration technique discussed above where a user's gaze is directed based on the received light intensity reflected from the user's eye. The training group may be used to create the trained neural network, which is applied to the calibration of any user to compensate for equipment shifts and detect the user's gaze. Additionally, a practice group may subsequently use the VR headset system to verify the accuracy of the trained neural network and to further improve detection of a user's gaze direction. The practice group may produce validation data to validate the trained neural network. The validation data may be used to analyze the performance of different architectures of the trained neural network and to select the architecture with a good balance between computational complexity and performance.

As discussed above, to map outputs of simulated sensor placement designs to gaze coordinates, a small MLP neural network is used. The advantage of such an approach is that the outputs of all sensors can be used as an input to the network, and predict gaze location for both horizontal and vertical gaze direction at once. Using all of the sensor values instead of, for example, calculating a combined response for each gaze direction separately, allows the network to explore non-linear relationships between the values from separate sensors and make better predictions about true gaze location. In various implementations, the photosensors of the VR headset system raw output data regarding the intensity of light reflected from the user's eye. The trained neural network is applied to the raw output data and coordinates of a location of a pupil of the user are determined.

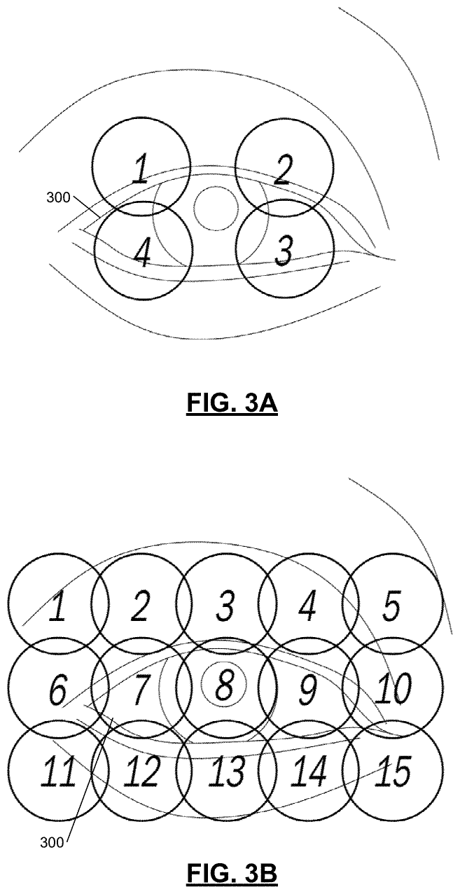

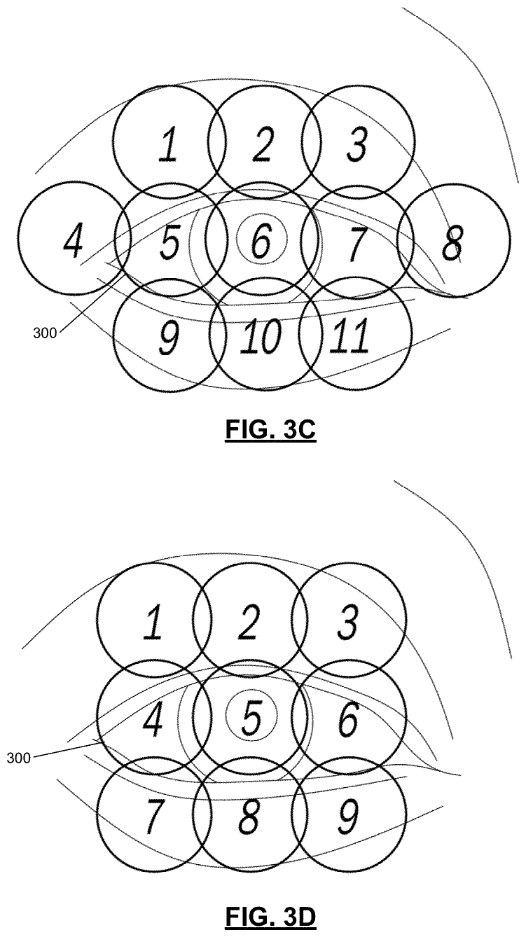

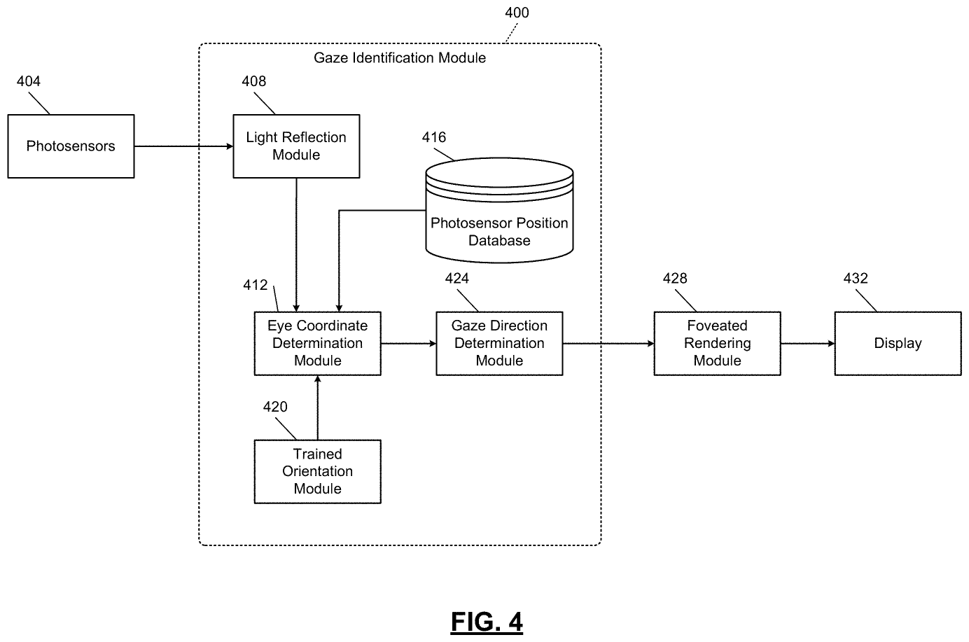

Referring to FIG. 3A, a four-sensor layout of the VR headset system is depicted. As described above, the output value of each photosensor changes when gaze location changes because of different amounts of light reflected from the eye's surface. This also applies for pupil dilations. However, in case of sensor shifts, sensors would “see” different parts of the eye and, in addition, illumination of the eye would also change. Therefore, the raw output data of each photosensor is a function of gaze direction, pupil size, sensor position, illumination, and noise. The main challenge for sensor shift compensation, without using external estimation of sensor position, is getting enough information about gaze position just from raw output data photosensor. As noted previously, raw output data values are mainly affected by sensor position and gaze direction.

In FIG. 3A, four receiving sensors 1, 2, 3, and 4 or photosensors are shown. While, in various implementations, the actual receiving sensors would be below the eye 300, the receiving sensors 1, 2, 3, and 4 depicted in FIG. 3A are showing from which areas of the eye 300 the receiving sensors 1, 2, 3, and 4 are receiving reflected light intensities. The layout in FIG. 3A is also shown in FIG. 1, where four photosensors are depicted in the sensor grid.

Sensor 1 vertically overlaps with sensor 4, and sensor 2 vertically overlaps with sensor 3. This design with four raw inputs is stable for vertical sensor shifts. However, in case of horizontal sensor shifts, performance of this design is satisfactory when the sensor is shifted to the left, while shifting sensors to the right degrades the performance.

FIG. 3B is a fifteen-sensor layout of the VR headset system. Each of the sensors shown in FIG. 3B slightly overlaps with neighboring sensors vertically as well as horizontally. This sensor layout performed best of tested designs. In FIG. 3C, an eleven-sensor layout of the VR headset system is depicted. This sensor layout also includes overlapping sensors, but the fifteen-sensor layout still performed better with higher accuracy. FIG. 3D depicts a nine-sensor layout with overlapping sensors. The sensor layout depicted in FIG. 3B is the most accurate, collecting the highest amount of raw data and covering most of the eye. Not only the number of sensors increase spatial accuracy with or without equipment shifts, but the placement of the sensors improves accuracy as well.

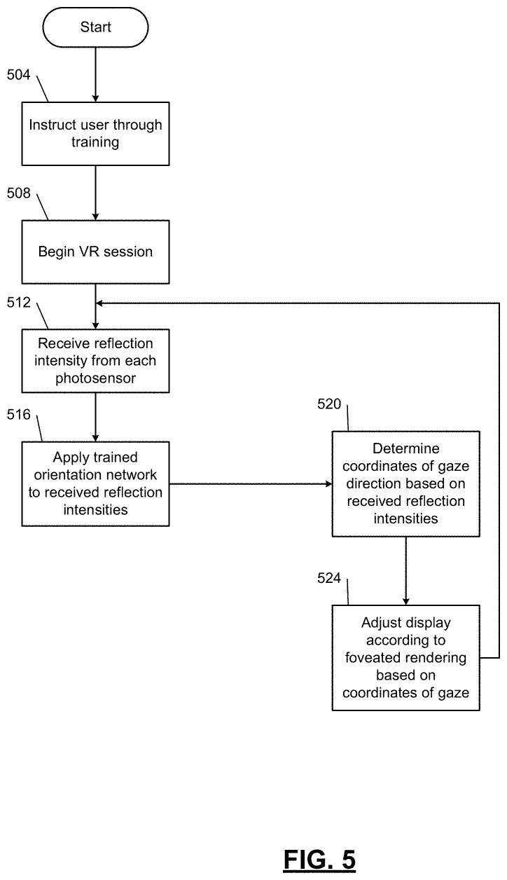

Referring to FIG. 4, a functional block diagram of a gaze direction identification module 400 is shown. The gaze direction identification module 400 receives raw output data from photosensors 404 included in the VR headset system. For example, the VR headset system may be the system described in FIG. 1. The raw output data received from the photosensors 404 indicates a light intensity reflected from an eye of the user of the VR headset system. The gaze direction identification module 400 includes a light reflection module 408, which receives the raw output data from the photosensors 404. In various implementations, the raw output data from the photosensors 404 may be a voltage value or another value that the light reflection module 408 converts into a light intensity value.

An eye coordinate determination module 412 receives the light intensity value from the light reflection module 408. The eye coordinate determination module 412 accesses a photosensor position database 416. The photosensor position database 416 includes position information of the photosensors included in the VR headset system. The eye coordinate determination module 412 applies a neural network included in a trained orientation module 422 to the light intensity values. Based on the known positions of the photosensors included in the photosensor position database 416 and the application of the neural network included in the trained orientation module 420, the eye coordinate determination module 412 determines a vertical and a horizontal coordinate of eye gaze direction of a user. As mentioned previously, this same coordinate identification may be applied to both eyes.

The gaze direction identification module 400 also includes a gaze determination module 424, which determines a gaze direction based on the coordinates received from the eye coordinate determination module 412. A foveated rendering module 428 receives the gaze direction of the user from the gaze direction identification module 400 and may adjust the image displayed to the user on a display 432 based on where the user is looking. As described above, knowing the gaze direction of the user, the display 432 may increase the quality of an image displayed according to where the user is looking. Additionally or alternatively, the foveated rendering module 428 may adjust the areas of the display 432 where the user is not looking to a lower quality image.

In various implementations, the system of FIG. 4 may use a low sampling rate and low-resolution camera (not shown). During calibration, such a setup could first map photosensor output to the patches of eye images obtained from the camera, and then use the eye images to simulate photosensor outputs in the case of a sensor shift. As a result, the system would have variable photosensor outputs for each eye position in a calibration plane, which could then be used to build the calibration function robust to sensor shifts. Note that the camera would not be required during the inference, thus using such an approach would be computationally similar to using pure PS-OG.

An alternative to using the camera image could be a micro-electro-mechan cal system (MEMS) scanner module. Provided that the scanner module is able to move and capture reflections from the eye in the same pattern as potential hardware shifts, the output of such a moving sensor could be used to train a calibration function. During the inference, the sensor could be static and sensor shifts could be corrected by MLP alone.

Referring to FIG. 5, a flowchart depicting gaze detection of a user is shown. Control begins at 504 where a VR headset system may instruct a user through a training. As described above, the training may include a dot or a set of dots where the user is instructed to look. Moreover, the training may include the user moving the headset to simulate equipment shifts that may occur during use of the VR headset system.

Once training is complete, control continues to 508 where the VR session begins. At 512, control receives reflection intensities from each photosensor in the form of raw output data. Control continues to 516 where control applies a trained orientation network (for example, the neural network described above) to the received reflection intensities. Control then continues to 520 where control determines coordinates of the user's gaze based on the received reflection intensities and the trained orientation network. Control proceeds to 524 and may adjust a display according to foveated rendering based on the determined coordinates of the user's gaze. Control continues to update the display based on the user's gaze throughout the VR session. In this way, the user has more freedom during the VR session as movements during the VR session will be accounted for in the display.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip. While various embodiments have been disclosed, other variations may be employed. All of the components and function may be interchanged in various combinations. It is intended by the following claims to cover these and any other departures from the disclosed embodiments which fall within the true spirit of this invention.

What is claimed is:

1. A virtual reality (VR) system comprising:
a light source configured to illuminate an area;
a plurality of photosensors configured to receive reflections from the illuminated area;
a trained orientation module configured to store a trained neural network model;
a gaze direction identification module coupled to the light source and the plurality of photosensors including:
a light reflection module configured to receive a light intensity value from each of the plurality of photosensors; and
an eye coordinate determination module configured to apply the trained neural network model to the light intensity value from each of the plurality of photosensors to determine a horizontal coordinate value and a vertical coordinate value, wherein the horizontal coordinate value and the vertical coordinate value indicate a gaze position within the illuminated area; and
a display configured to adjust a displayed image based on the gaze position of the illuminated area.

2. The VR system of claim 1 wherein the gaze direction identification module is configured to:
identify a portion of a present display image that corresponds to the gaze position.

3. The VR system of claim 2 wherein the display is configured to adjust the displayed image by:
improving a quality of the identified portion of the present display image for display.

4. The VR system of claim 1 wherein the trained neural network model receives calibration data for each user.

5. The VR system of claim 4 wherein the calibration data for a first user is obtained by:
for each known image location of a set of known image locations, storing a corresponding light intensity value, wherein the corresponding light intensity value is obtained when a gaze direction of the first user is directed to the corresponding known image location.

6. The VR system of claim 1 wherein the trained neural network model is a multi-layer perceptron neural network configured to implement a mapping function.

7. The VR system of claim 1 wherein the trained neural network model is a convolutional neural network trained using a training set including position and light intensity correspondence information.

8. The VR system of claim 1 further comprising a mirror configured to direct reflections from the illuminated area to the plurality of photosensors.

9. The VR system of claim 1 wherein the plurality of photosensors are:
configured to measure an intensity of reflections that correspond to the light intensity value, and
arranged in a grid.

10. The VR system of claim 1 wherein adjusting the displayed image includes orienting the displayed image based on the gaze position indicating a viewing direction.

11. The VR system of claim 1 wherein an eye of a user is placed at or near the illuminated area.

12. The VR system of claim 1 further comprising a power source configured to supply power to the light source, the plurality of photosensors, and the gaze direction identification module.

13. The VR system of claim 12 wherein the power source is a battery.

14. The VR system of claim 1 wherein the display is configured to display instructions to guide a new user through training.

15. A virtual reality (VR) method comprising:
illuminating an area with a light;
receiving reflections from the illuminated area at a plurality of photosensors;
receiving a light intensity value from each photosensor of the plurality of photosensors;
determining a gaze direction by applying a trained machine learning algorithm to the received light intensity values;
obtaining a present display screen;
determining an area of the present display screen corresponding to the gaze direction;
adjusting the area of the present display screen; and
displaying a display screen including the adjusted area of the present display screen.

16. The VR method of claim 15 wherein positional information is stored for each photosensor of the plurality of photosensors.

17. The VR method of claim 16 wherein the gaze direction includes a horizontal coordinate value and a vertical coordinate value.

18. The VR method of claim 15 wherein the adjusting the area of the present display screen includes:
improving an image quality of the area of the present display screen.

19. The VR method of claim 15 wherein the adjusting the area of the present display screen includes:
reducing an image quality of the present display screen excluding the area of the present display screen.

20. A virtual reality (VR) system comprising:
a light source configured to illuminate an area;
a plurality of photosensors configured to receive reflections from the illuminated area;
at least one processor; and
a memory coupled to the at least one processor,
wherein the memory stores:
a trained neural network model;
a photosensor position database including for position information of the plurality of photosensors included in the VR system; and
instructions that, upon execution, cause the at least one processor to:
receive a light intensity value from each photosensor of the plurality of photosensors;
determine a horizontal coordinate value and a vertical coordinate value corresponding to a gaze direction by applying the trained neural network model to the light intensity values of each photosensor;
obtain a present display;
adjust the present display based on the horizontal coordinate value and the vertical coordinate value; and
display the adjusted present display.
